(19) United States
(12) Patent Application Publication
(10) Pub. No.: US 2014/0274007 A1
(43) Pub. Date: Sep. 18, 2014

(54) System and Method for Enhancing the Probability of a Successful Communication Event Between the Users of Mobile Devices within an Intended Period of Time

(71) Applicant: Motorola Mobility LLC, Libertyville, IL (US)

(72) Inventors: Craig J. Detter, Gurnee, IL (US); Alan S. Hshieh, Cupertino, CA (US); Daniel C. Wong, San Jose, CA (US)

(73) Assignee: Motorola Mobility LLC, Libertyville, IL (US)

(21) Appl. No.: 13/950,451

(22) Filed: Jul. 25, 2013

Related U.S. Application Data
(60) Provisional application No. 61/781,290, filed on Mar. 14, 2013.

(51) Int. Cl. H04M 3/54; H04W 4/16

(52) U.S. Cl. CPC H04M 3/54; H04W 4/16
USPC 455/417

(57) ABSTRACT

A method includes detecting a first call placed with a first mobile device by a caller to a called party with a second mobile device and not answered by the called party, determining at least one candidate contact having a third mobile device, an association with the called party, and a probability of being in proximity to the called party at the time of the first call; and placing a second call using the first mobile device to the third mobile device. The method may include determining the association of the candidate contact with the called party, and determining the probability that the candidate is in proximity to the called party at the time of the first call. The probability determination may include generating a list of candidate contacts from an association map, where each of the candidates has an association with the called party according to the association map.

### CROSS-REFERENCE TO RELATED APPLICATIONS

The present disclosure claims priority to U.S. Provisional Pat. App. No. 61/781,290 “SYSTEM AND METHOD FOR ENHANCING THE PROBABILITY OF A SUCCESSFUL COMMUNICATION EVENT BETWEEN THE USERS OF MOBILE DEVICES WITHIN AN INTENDED PERIOD OF TIME,” filed on Mar. 14, 2013 and which is hereby incorporated herein in its entirety.

### FIELD OF THE DISCLOSURE

The present disclosure relates generally to mobile devices and more particularly to contact databases and methods of contacting a called party.

### BACKGROUND

In attempting to contact a called party using a wireless communications system, often times the user of a first mobile device may be unsuccessful when attempting to communicate with the user of a second mobile device at a given period of time. This could be due to a variety of reasons. For example, when the user of the second mobile device is not within close proximity to that device he or she may not be aware that someone is trying to call, or the second mobile device may turned off or may be set to a mode such as “Silent” or “Vibrate,” etc., during the period of time such that the called party is unable to detect the incoming call.

### BRIEF DESCRIPTION OF THE DRAWINGS

FIG. 1 is a block diagram of a mobile device having a contract tracker and communicating with a server in accordance with an embodiment.

FIG. 2 is block diagram showing nodes of an association map in accordance with an embodiment.

FIG. 3 is partial schematic block diagram of a mobile device and a server in accordance with various embodiments.

FIG. 4A is block diagram showing interfacing between a mobile device contact tracker and a server in accordance with an embodiment and FIG. 4B is block diagram showing a notification that may be provided to a mobile device by a server in some embodiments.

FIG. 5 is a partial schematic block diagram of a mobile device in accordance with some embodiments.

FIG. 6 is a flow chart illustrating a high level method of operation of a mobile device in accordance with various embodiments.

FIG. 7 is a flow chart illustrating a high level method of operation of a server in accordance with various embodiments.

FIG. 8 is a flow chart illustrating a method of operation of a server that creates an association map and adds association map nodes in accordance with various embodiments.

FIG. 9 is a flow chart illustrating a method of operation of a server in accordance with various embodiments.

FIG. 10 is a flow chart providing further details of the method of operation illustrated in FIG. 9.

### DETAILED DESCRIPTION

The present disclosure provides a method of operation that includes detecting that a first call placed by a caller using a first mobile device to a called party using a second mobile device was not answered by the called party using the second mobile device. The method of operation includes determining at least one candidate contact with a third mobile device who has an association with the called party and a probability of being in proximity to the called party at the time of the first call. A second call may then be placed using the first mobile device to call the third mobile device.

The method may also include determining the association of the at least one candidate contact with the called party, and determining the probability that the at least one candidate is in proximity to the called party at the time of the first call. This may be accomplished by generating a list of candidate contacts from an association map, where each of the candidates has an association with the called party. Based on the association, at least one candidate contact is determined that has a probability of being in proximity to the called the called party at the time of the first call. The association may be made based on at least one of calendar information, history of communication with the called party, or location information collected from the third mobile device.

The method may include determining at least one candidate from the list of candidate contacts that has the highest probability of being in proximity to the called party. In some embodiments the method may include obtaining location information from the third mobile device of the at least one candidate selected from the list of candidates, and determining that the location information is for a location that is in proximity to the called party at the time of the first call.

The method may include generating the association map by creating a group of association map nodes where each node corresponds to a contact in the association map. The method may include generating the association map by accessing information on at least one mobile device for each node of the association map. The accessed information may be call logs, user history, contact lists stored on the mobile device, social networking contact lists, calendar entries, sensor data, or location data.

Generating the association map may include categorizing various contacts corresponding to each node of the association map and creating associations for each node based on the categorizations. For example, contacts corresponding to each node may be categorized as a family member, coworker, business contact, or social contact. Various time associations may also be created between the various contacts or nodes.

In one disclosed embodiment, a mobile device is operative to perform the various disclosed methods and includes a dialer, operatively coupled to at least one communication transceiver, and a contact tracker, operatively coupled to the dialer. The contract tracker is operative to perform the various disclosed methods of operation.

A system is also disclosed that includes a server operatively coupled to a database. The database contains an association map that has various nodes. Each node corresponds to a contact and has at least one association with a different node. The associations define, among other things, relationship categories such as, but not limited to, family member, coworker, business contact, or social contact. The associations may also include location information, time and date for at least one node. The system includes a mobile device that is operatively coupled to the server. The mobile device includes a dialer, operatively coupled to at least one communication transceiver and a contact tracker, operatively coupled to the dialer. The contract tracker can detect that a first call placed by a caller using a first mobile device to a called party using a second mobile device was not answered by the called party using the second mobile device. The contact tracker then obtains, from the server, at least one candidate contact having a third mobile device, an association with the called party, and a probability of being in proximity to the called party at the time of the first call, and places a second call to the third mobile device.

Turning now to the drawings wherein like numerals represent like components, FIG. 1 is a block diagram of a system that includes a mobile device 110 having contact tracker 100 and communicating with a server 140 in accordance with an embodiment. The server 140 may be a cloud-based server and is accessible via a network 150 which may be, for example, the Internet or some other IP-based network. The server 140 may either include, or be operatively coupled to, a database 160 which contains an association map 200 in accordance with an embodiment. The mobile device 110 may communicate with various other mobile devices such as the group of mobile devices 130. The group of mobile devices 130 includes at least mobile devices 131, 132, 133 and may include additional other devices as shown. Each one of the mobile devices of the group of mobile device 130 may communicate with the server 140 to send various update information and other information. For example, the server 140 may collect location information, environment sensor information, application state or usage data, device state, or other information, from the group of mobile devices 130. Each mobile device of the group of mobile devices 130, and the mobile device 110, have an account with the server 140 and may login to the server 140 either by user action or by an automatic login feature of a corresponding contact tracker operating on the respective mobile device. For example, mobile device 110 includes the contact tracker 100 which may automatically, and from time to time, log into the server 140 to provide certain information. Additionally, the contact tracker 100 may inform the server 140 of various actions taken by the mobile device 110. In one example, the mobile device 110 may place a call over a wireless communication channel 121 through the wide area network (WAN) 120 in an attempt to contact a called party who is a owns, or uses, a mobile device of the group of mobile devices 130. For example, the caller (i.e., user or owner of mobile device 110) may try to call mobile device 132. Previously, or in the interim, the mobile device 132 may have sent information 135 to the server 140. Likewise mobile device 131 may have sent information 134 to server 140, and mobile device 133 may have sent information 136 to server 140. For example, mobile device 131 may use wireless communication channel 123 to communicate with the server 140. The information being sent may include location information, device state information, environment sensor information, application state or usage data, or any other type of information, etc. regarding the specific mobile device.

When the mobile device 110 places the call through the WAN 120, the contact tracker 100 may intercept information related to the call attempt and send call attempt information 101 to the server 140. The server 140 may then monitor the mobile device 110 actions using the contact tracker 100 to determine if the call was successful or not. That is, if the call to mobile device 132 goes unanswered or is redirected to a voicemail server, the contact tracker 100 may detect this by interfacing with various components or circuitry of the mobile device 110. The mobile device 110 will inform the server 140 which may, in response, send augmented contact information 103 that may be used to redirect the call to another mobile device of the group of mobile devices 130. In one use case example, the called party may have mobile device 132 turned off or set to silent mode such that the called party is unable to detect the incoming call on mobile device 132. However, the server 140 will be able to determine whether one of the other mobile devices of the group of mobile devices 130 is within proximity of mobile device 132 and, correspondingly, in proximity to the called party. For example, mobile device 131 may be in proximity to mobile device 132. The server 140 analyzes an association map 200 contained in the database 160 and determines an association between the called party who owns or uses mobile device 132, and the owner or user of mobile device 131. The server 140 may also determine associations between other mobile devices of the group of mobile devices 130 and between mobile device 110. Based on the association or associations determined using the association map 200, and other information including probability calculations, the server 140 may determine that mobile device 131 may be useful for contacting the called party who owns or uses mobile device 132. The server 140 will then proceed to send augmented contact information 103 to the contact tracker 100 which may then be displayed to the user on mobile device 110. That is, the user may be notified of an alternative approach to contacting the called party.

The terms “user” and “caller” as used herein refer to an owner or user of a mobile device who initiates a call or messaging operation to a called party using the respective mobile device. The “called party” as used herein refers to the person being contacted and may be an owner or user of another mobile device, such as one (or more) of the mobile devices of the group of mobile devices 130 shown in the FIG. 1 example. Thus, in the example under discussion, the user of mobile device 110 who is the caller may use the augmented contact information 103 to call mobile device 131 in the caller's attempts to reach the called party. The mobile device 131 however may be owned or used by another person other than the called party. Such other person is referred to herein as a “candidate contact” and has been determined by the server 140 to have a probability of being in within proximity of the called party.

With respect to communication between the various mobile devices and the server 140, the WAN 120 may be connected to the network 150 by a backhaul connection 151 such that the mobile device 110 and the group of mobile devices 130 may communicate with the server 140 and the corresponding network 150 using the wide area network 120. However, the mobile device 110 and group of mobile devices 130 may use any other suitable wireless or other network to communicate with network 150 and the server 140.

FIG. 2 is diagram representing an association map 200 in accordance with an embodiment. Among other things, the association map 200 creates time associations between various nodes contained in the association map. Each node of the association map corresponds to a person who may, or may not be a contact of any other person corresponding to a node. For example, the caller will have a node 201 on the association map 200 and the called party may have a node 213 on the association map 200. Various intervening nodes, such as node 203, may correspond to persons known or unknown to the caller or the called party. The server 140 periodically updates the association map 200 to create categories, time associations, and other associations such that various nodes may be determined to have a probability of being within proximity of one another at given points or periods of time. Put another way, the nodes correspond to contacts that may be used as intermediary contacts between the caller and the called party, depending upon the various associations that may exist between the nodes. Such intermediary contacts may be candidates at any given time based on various factors such as, but not limited to, the candidate's proximity to a called party.

The time associations and other associations may thus be used by the server 140 to provide augmented contact information to the mobile device 110, via contact tracker 100. The augmented contact information will correspond to one of the nodes of the association map 200 that may increase the probability of contacting a called party even when the called party is unreachable via their own mobile device. The called party may be unreachable due to any number of reasons such as their respective mobile device being turned off, out of battery power, or in a mode setting that does not allow the called party to detect an incoming call.

Although the association map 200 shown in FIG. 2 appears in the figure as a two-dimensional object, the association map 200 may have any number of dimensions mathematically and may therefore be viewed as a multidimensional graphical representation. The multidimensional aspect may be achieved through the use of various vectors and matrices to create relationships between the various nodes. Put another way, the various nodes may be related via various categories such as, but not limited to, contact type, physical location or proximity, and time. The association map 200 is dynamic in that it may change with time as is updated by the server 140 periodically as the server 140 obtains information updates from the mobile device 110 and from the group of mobile devices 130.

In FIG. 2, the dotted line portions represent various possible categorizations or groupings which are types of associations and that may be used to determine other associations. For example, the caller node 201 may be contained within the time association 209 which includes various nodes as shown at some particular interval or point of time. Overlapping with the time association 209 may be another association such as family association 207 which includes family members of the caller corresponding to caller node 201. The caller node 201 may also be included in a coworkers association 205. The association map 200 may make other associations that do not overlap at a particular time such as friends association 211 which, in this example, includes the called party node 213.

As an example, if the called party corresponding to caller node 201 attempted to contact a called party corresponding to called party node 213 and the call was unsuccessful, the server 140 searches the association map 200 to locate another node which represents a person having an association with the called party and who has a probability of being in proximity to the called party corresponding to node 213. Referring to the example discussed above with respect to FIG. 1, if one of the group of mobile devices 130 is used or owned by one of the candidate contacts corresponding to an association map 200 node, then the server 140 may inform the contact tracker 100 of the mobile telephone number of the mobile device corresponding to the node. That is, provided that the mobile device relates to a person who has a high probability of being within proximity of the called party. The association map 200 is created by the server 140 by collecting information from the various mobile devices and searching through various other sources of information as will be described in detail herein.

A partial schematic block diagram of the mobile device 110 and server 140 is provided in FIG. 3. In accordance with various embodiments, the mobile device 110 includes a contact tracker 100. The contact tracker 100 may be composed of various components such as server communication logic 105, association map updater 106, outgoing call/message interceptor 107, and redirector 108. The contact tracker 100 or any of its components may be implemented independently as software and/or firmware executing on one or more programmable processors (including CPUs and/or GPUs), and may also include, or may be implemented independently, using ASICs, DSPs, hardwired circuitry (logic circuitry), or combinations thereof. That is, the contact tracker 100 may be implemented using an ASIC, DSP, executable code executing on a processor, logic circuitry, or combinations thereof. The contact tracker 100 or any of its components may be referred to as “logic” herein and may be implemented in any of the various ways described above in accordance with various embodiments.

The various components of the contact tracker 100 are operatively coupled to one another as shown by communication path 109. The communication path 109 may be implemented by a communication bus in some embodiments or, in other embodiments, may be implemented by software coupling. As used herein the term “software coupling” refers to application programming interfaces (APIs) or libraries that facilitate sharing of information, receiving or sending commands, etc., in order to facilitate operations and functionality between the various components when such components are implemented as software or firmware. Additionally, the contact tracker 100 may communicate with various components or applications of the mobile device 110 using other appropriate operative coupling such as software coupling. For example, the outgoing call/message interceptor 107 may communicate with dialer 112, and one or more messaging applications 113, using the respective communication paths 115 and 117, which provide operative coupling and as discussed above may be software coupling and may be facilitated by libraries or APIs as appropriate. Likewise, redirector 108 may communicate with the dialer 112 and messaging applications 113 via communication paths 116 and 118, respectively, which provide operative coupling and may be software coupling in some embodiments.

As described with respect to FIG. 1, the contact tracker 100 communicates with the server 140, which may be a cloud server, and which may be located within the network 150 which may be the Internet or some other IP-based network. The server 140, in accordance with embodiments, includes contact finder 170. The communication between the contact tracker 100 and the server 140 may be accomplished by a communication channel 125, which may be a bidirectional wireless channel through the WAN 120, or which may be “connectionless” such as an Internet Protocol (IP) connection provided by the WAN 120, or some other suitable network, in some embodiments.

The contact finder 170 may be implemented as software or firmware executing on at least one processor of the server 140 and may include the components mobile communication logic 171, association mapping logic 173 and at least one searching routine 175. The mobile communication logic 171 is operatively coupled to the association mapping logic 173 by communication path 177 which may be facilitated by software coupling. Likewise the mobile communication logic is operatively coupled to the searching routine 175 by communication path 178 which may be facilitated by software coupling. The contact finder 170 is also operatively coupled to the database 160 which contains the association map 200 as was discussed above. An operative coupling between the server 140, contact finder 170 and the database 160 is accomplished by communication path 176 which may be, or may include, software coupling. The software coupling provides access to the database 160 association map 200 by the association mapping logic 173 and the searching routine 175. The searching routine 175 may use various algorithms such as, but not limited to, Dijkstra's algorithm or other appropriate algorithms to search through the association map 200 nodes and establish paths through the various associations. The software coupling over communication path 176 may be accomplished using libraries or APIs or may include database interoperation interfaces such as but not limited to SQL or any other suitable database protocol or interface. In embodiments where the cloud server 140 is a cloud based server, the contact finder 170 or any of the components shown in FIG. 3 may be distributed among various cloud servers. Similarly, the database 160 and the association map 200 may be distributed among various cloud based database servers in some embodiments.

The mobile device 110 includes a dialer 112 and one or more messaging applications 113 that are operatively coupled by communication path 119 to one or more communication transceivers 111, one of which is operative to establish communication channel 125. The server communication logic 105 is operatively coupled to the one or more communication transceivers 111 by communication path 114, and communicates with mobile communication logic 171 over the communication channel 125. The mobile device 110 uses the dialer 112 to receive the caller's entered digits to place a call or may use the one or more messaging applications 113 to send messages such as text messages to a called party.

The contact tracker 100 may detect that an outgoing call is being made when the outgoing call/message interceptor 107 detects digits being entered by the user (i.e. the caller) via dialer 112 over the communication path 115. The outgoing call/message interceptor 107 may then provide the dialed digits or other information to the server communication logic 105 for transmission to the server 140 using the communication transceivers 111 and wireless communication channel 125. The mobile communication logic 171 of the contact finder 170 receives the information sent by the contact tracker 100 and takes appropriate action. The outgoing call/message interceptor 107 may also make a determination of whether the mobile device that was called using the dialer 112 answered the call such that the call was a successful call. That is, the outgoing call/message interceptor 107 may make a determination of whether the called mobile device answered the call and established a communication channel with the mobile device 110, whether a ring back signal was received and call continued to go unanswered by the called mobile device, or whether the call was directed to a voicemail server. Any one of those events may be considered an unsuccessful call.

In that case, the outgoing call/message interceptor 107 will send notification to the contact finder 170 via the server communication logic 105. The notification will be received by the mobile communication logic 171 and the contact finder 170 will take appropriate action. That is, for an unsuccessful call, the contact finder 170 will invoke the searching routine 175 which will search the association map 200 in the database 160 to determine a candidate (that is, an alternative mobile device for an alternative called party) that the caller may attempt to contact so as to locate the initial called party who did not respond to the call. The searching routine 175 determines one or more nodes of the association map 200 that are candidates based on various factors and probability calculations and provides at least one candidate having a highest probability of being in proximity to the called party or, in some embodiments, the called party's mobile device. After the highest probability candidate is determined, the mobile communication logic 171 will transmit augmented contact information over the wireless communication channel 125 to the mobile device 110. The augmented contact information will be received by the contact tracker 100, via server communication logic 105, which will then be provided via communication path 109 to redirector 108. Redirector 108 may then interact with the dialer 112 over the communication path 116 or may interact with messaging applications 113 over the communication path 118. The redirector 108 may attempt to establish a new, second call with the candidate, or in some embodiments may send a text message to the candidate. In some embodiments, the caller (i.e. the mobile device 110 user) may be provided notification of the candidate and given a choice as to whether to proceed to contact the candidate or not. In this case the redirector 108 will wait to receive permission from the caller to proceed with attempting to contact the candidate.

The diagrams of FIG. 4A and FIG. 4B are helpful for understanding various use cases and interactions between the server 140 and various mobile devices. Among other things, FIG. 4A illustrates further details of operation of the association map updater 106 and the association mapping logic 173 which resides on server 140. The mobile device 110 in FIG. 4A is shown displaying a call log 403 which displays a list of incoming, outgoing and missed calls. The example call log 403 lists various contact names and associated indicators such as incoming call indicator 407, outgoing call indicator 409 and missed call indicator 413. The call log 403 entries may also show a date 405 and possibly a time such that the user of mobile device 110 knows when calls were placed, received, or missed. As is known to those of ordinary skill, the user of mobile device 110 may position a cursor 411 with respect to a desired entry in the call log 403 and may initiate a call directly from the call log 403. For example, the user may position cursor 411 over the contact “Allen Jones” and may make a selection such that the dialer 112 initiates a call to Allen Jones. The dialer 112 will then interact with the communication transceivers 111 over communication path 119 to establish a wireless communication channel using WAN 120, or some other appropriate network, and will attempt to place a call to the appropriate mobile device of the called party Allen Jones.

As was discussed with respect to FIG. 1, call attempt information 101 is transmitted by the contact tracker 100 to the server 140 which is used by the contact finder 170. In one example, the contact finder 170 extracts the contact information for Allen Jones and creates a corresponding node in the association map 200. The association map updater 106 component of the contact tracker 100 may access various resources to provide further information regarding the association of Allen Jones to the caller. For example, the association map updater 106 may interact with contact list 415, calendar application 417, social media application 419, various sensors 421 of the mobile device 110 that sense the environment, or various call logs 423 such as the call log 403. If any data entries or other references to the called party Allen Jones are identified by the association map updater 106, that information will be sent as updates 406 to the server 140, more specifically to the association mapping logic 173 of contact finder 170.

The association mapping logic 173 will accordingly update or modify the association map 200. Returning to the example briefly mentioned above where the caller uses mobile device 110 to place a call to Allen Jones using the call log 403 entry, the contact finder 170 waits to determine whether the call is successful or unsuccessful. If the call is determined to be unsuccessful, the searching routine 175 proceeds to search the association map 200 to determine a candidate (i.e. an alternative contact) who may be in proximity to Allen Jones. If an appropriate candidate is identified by the searching routine 175, then the contact finder 170 sends augmented contact information, which may be considered call redirect information, to the mobile device 110.

The contact tracker 100 receives the augmented contact information and may provide, in some embodiments, the notification message 427 to the user of mobile device 110. The notification message 427 queries the user as to whether the contact tracker 100 should continue to locate Allen Jones, since the original call attempt was unanswered or went to voicemail and was therefore deemed unsuccessful by the contact finder 170. The user may select “NO” in which case the process ends, or the user may select “YES” in which case the redirector 108 will use the augmented contact information received and attempt to contact the mobile device of the candidate. As discussed above the candidate will correspond to a node of the association map 200 and will have a probability of being in proximity to Allen Jones.

FIG. 5 is another partial schematic block diagram of a mobile device 110 in accordance with some embodiments. FIG. 3, which was described above, and FIG. 5 are partial schematic block diagrams of mobile devices and servers that are examples of apparatuses in accordance with various embodiments. FIG. 3 and FIG. 5 provide examples of mobile devices and servers for the purpose of describing to those of ordinary skill how to make and use the disclosed subject matter by way of various embodiments. It is to be understood that these figures provide partial schematic block diagrams in that, although the diagrams show at least those components necessary to describe the features and advantages of the various embodiments to those of ordinary skill, various other components, circuitry, and devices may be necessary in order to implement a complete functional apparatus such as the example mobile devices, and example servers, and that those various other components, circuitry, devices, etc., even though not shown, are understood to be present by those of ordinary skill.

Thus, the partial schematic block diagram of FIG. 5 illustrates an example embodiment of mobile device 110 where the contact tracker 100 is implemented as executable code executed by a processor 501. The executable code corresponding to the contact tracker 100 may be stored in non-volatile, non-transitory memory such as memory 511 as shown, and read from memory 511 as needed for execution by processor 501. Further, the contact tracker 100 may be executed as part of a software stack 502. The contact tracker 100 may include the server communication logic 105, association map updater 106, outgoing call/message interceptor 107 and redirector 108, which provide features and functions as were discussed above with respect to FIG. 3. In some embodiments, some of the components attributed to the server 140 in FIG. 3 may be included in the contact tracker 100. These components include the association mapping logic 173 and the searching routine 175 which are represented using dotted lines to illustrate that they may be present in the contact tracker 100, or remotely on a server as shown in FIG. 3. Likewise, the association map may be stored in the mobile device 110, or may be distributed with a portion stored on the mobile device 110 and a portion stored remotely. Each of the components shown in FIG. 5 have corresponding executable code, within the contact tracker 100 executable code stored in memory 511, and such executable code is also executed by the processor 501 in accordance with the example embodiment of FIG. 5. The contact tracker 100 may also communicate and interact with one or more applications 503 which are also executed by the processor 501, or with other components of mobile device 110. The applications 503 may also be stored as executable code (not shown) in memory 511. The various components of contact tracker 100 are each operatively coupled to each other by communication path 109 which is software coupling in this example, and each of the components may also communicate with various application programming interfaces (APIs) 504 for interfacing and communicating with one or more of the applications 503. Some of the applications 503 that the contact tracker 100 may interface with through the APIs 504 include, but are not limited to, a calendar application 417, a social media application 419, a dialer 112, and a messaging application 113.

The mobile device 110 is one kind of apparatus in accordance with an embodiment and includes connection bus 505 to provide operative coupling between various components including the at least one processor 501, memory 511, communication transceivers 111 (which include network transceiver 507 and peer-to-peer transceiver 509), display/GUI 513, other UI 515, sensor hub 517, etc. The connection bus 505 provides operative coupling in that various intermediate or intervening mobile device 110 components, circuitry, and the like, may exist in between, and/or along, the communication path between any two or more operatively coupled components, etc.

It is to be understood that FIG. 5 illustrates examples of components that may be present in a mobile device 110 and that one or more of the various components shown in FIG. 5, other than the contact tracker 100, may be omitted from the mobile device 110 without detracting from enjoyment of the benefits, features and advantages of the present disclosure. That is, different mobile devices may or may not include some of the example components shown in FIG. 5 and therefore none of these example components are to be construed as being required for any particular embodiment.

The display/GUI 513, if present, may provide a touchscreen user interface and, in some embodiments, may also provide a graphical user interface (GUI). The network transceiver 507, if present, may provide wireless communication capabilities for one or more wide area network communications systems such as, but not limited to, Wi-Fi cellular, 2G, 3G or 4G wireless communications systems. The peer-to-peer transceiver 509, if present, may provide wireless connectivity capabilities such as, but not limited to, Bluetooth™, Wireless USB, ZigBee, or other technologies, etc. such as near field communication (NFC). The other UI 515, if present, may include a track ball mouse, etc., and may communicate with sensor hub 517. The sensor hub 517 includes communication bus 518 and provides interfaces for a group of sensors 421 that may include touch sensitive elements, physical switches, gyroscopic position sensors, accelerometers, thermometers, etc. The display/GUI 513, if present, may include touchscreen functionality as noted above, and may be operative to receive command and control signals from the other UI 515 directly, or via the processor 501, of via sensor hub 517, for functions such as, but not limited to, mouse cursor control click to provide selection input and or drag and drop features or other functionality in some embodiments.

The memory 511 is a non-volatile, non-transitory memory, and stores the executable code corresponding to the contact tracker 100 including any component logic. The processor 501 is operative to execute the executable code, which may be stored in memory 511, to perform the methods of operation disclosed herein.

The various embodiments also include non-volatile, non-transitory computer readable memory, other than memory 511, that may contain executable instructions or executable code, for execution by at least one processor, that when executed, cause the at least one processor to operate in accordance with the functionality and methods of operation herein described for either a mobile device, a server, or both. The computer readable memory may be any suitable non-volatile, non-transitory, memory such as, but not limited to, programmable chips such as EEPROMS, flash ROM (thumb drives), compact discs (CDs) digital video disks (DVDs), etc., that may be used to load executable instructions or program code to other processing devices such as mobile devices, servers or other devices such as those that may benefit from the features of the herein described embodiments.

FIG. 6 is a flow chart illustrating a high level method of operation of a mobile device in accordance with various embodiments. Referring to the example of a mobile device 110 shown in FIG. 5, the method of operation begins in block 601, and the mobile device 110 records state information as shown in block 603. For example mobile device 110 may collect information from the group of sensors 421 which are operatively coupled by communication bus 518 to the sensor hub 517. In addition to the possible sensors noted above, the sensors 421 may include, but are not limited to, a light sensor, temperature sensor, gyroscopic position sensor, infrared LED touch sensor, capacitive touch sensor, accelerometer, ambient audio sensor, or any other type of sensor from which environment data may be collected. The association map updater 106 may be responsible for collecting the environmental sensor information and may either transmit raw sensor information or may perform some analysis on the sensor information prior to transmitting it to the server 140. For example, the association map updater 106 may apply certain algorithms to the environment sensor information and make determinations as to whether the mobile device 110 is in motion, in a vehicle, in a high noise environment, on a train or some other form of transportation that has a certain associated known vibration or movement pattern, or some other processing on the data to augment it prior to sending it to the server. In other embodiments, the server 140 will receive raw data and perform any such necessary processing accordingly. In addition to environment information collected through the sensor hub 517, the association map updater 106 may also collect location information from location detection 519 or from the near field proximity detection 521 in some embodiments. All of the information collected will be used by the server 140 to make some determination as to the state and location of mobile device 110, in conjunction with the association map 200, and will determine what other nodes in the association map 200 may be in proximity to the mobile device 110 at any given period of time.

Thus as shown in block 605, association map updater 106 will provide the state information to server 140. Blocks 607 and 609 correspond to the dialer 112 receiving a selection of new dialed digits in order to place a call. That is, the outgoing call/message interceptor 107 may receive the input for the caller messaging attempt from either the dialer 112 or messaging application 113, in block 607 using an appropriate one of the APIs 504, and may provide the received input to server 140 is shown in block 609. If the call is unsuccessful as was discussed above, server 140 will send augmented contact information to the mobile device 110. As shown in block 611, contact tracker 100 may receive the augmented contact information from the server 140. As shown in block 613, the redirector 108 may proceed with the call to the high probability candidate or may attempt to contact the high probability candidate using messaging based on the received augmented contact information. The method of operation then ends in block 615 as shown.

FIG. 7 is a flow chart illustrating a high level method of operation of a server in accordance with various embodiments. Referring to the server 140 shown in FIG. 3, the method of operation begins in block 701 as shown and the mobile communication logic 171 receives call attempt information in block 703. The call attempt information may be detected by the outgoing call/message interceptor 107 in mobile device 110 and sent to the server 140. The searching routine 175 then determines a relationship or association of the called party with the caller is shown in block 705. This is done by searching the association map 200 as was discussed above. Searching routine 175 also determines relationships or associations of the called party to other parties, which correspond to other nodes in the association map 200, as shown in block 707. Then, in block 709, the searching routine 175 uses the association map 200 to determine how to contact the called party by using a mobile device of an associated contact (i.e. a candidate) from the association map 200. The server 140 provides augmented contact information with the appropriate information for that contact to the caller as shown block 711. The method of operation ends as shown in block 713.

FIG. 8 is a flow chart illustrating a method of operation of a server that creates an association map in accordance with various embodiments. With reference to the server 140 shown in FIG. 3, a method of operation of the server 140 begins in block 801 as shown. In block 803, the server 140 checks a relevant mobile device for data collection permission settings. These data collection permission settings may be stored in memory of the particular mobile device. In addition to the association map 200 which is stored in the database 160, server 140 also has access to a collection of privacy rules (not shown) which may also be stored in the database 160 or may be stored in another remote database within the network 150, or within the respective mobile device. The mobile device 110, and each of the mobile devices of the group of mobile devices 130, may have associated privacy rules in the remote database. These user privacy settings control how information is gathered and accessed on each of the particular mobile devices and may be settable by the mobile device users in some embodiments. Therefore as shown in decision block 805, the server 140 checks the privacy rules, for the specific user corresponding to the mobile device, to see if the data collection operation about to be performed is in compliance with the privacy rules for that user. If the privacy rules are violated in decision block 805, then the method of operation ends as shown in block 825. However if the privacy rules are complied with in decision block 805, then the server 140 proceeds with the method of operation and may obtain various information such as location data in block 807, call logs in block 809, user histories in block 811, local contact lists in block 813 such as those stored in memory of the mobile device, social networking contact lists in block 815, calendar entries in block 817 and device sensor data in block 819. The association mapping logic 173 will then analyze the data before determining the position of the node corresponding to the mobile device within the association map 200. In order to accomplish this, the association mapping logic 173 may apply weighting factors as shown block 821. That is, based on the collected data, some factors may increase certain probabilities over others. As shown in block 823, the association mapping logic 173 then creates the association map node for the user and for the particular mobile station from which data is being collected. The process then ends as shown in block 825.

FIG. 9 and FIG. 10 provide further details of a method of operations of a server in accordance with various embodiments. Referring again to the server 140 shown in FIG. 3 which has the corresponding contact finder 170, a method of operation begins in block 901. The contact finder 170 begins to monitor specific mobile devices for call attempts as shown in input block 903. In block 905, the contact finder 170 may obtain called number contact information from various mobile devices. For example, as was discussed above previously, mobile device 110 contact tracker 100 has an association map updater 106 component that may monitor various information of the mobile device 110 and send those information updates to the contact finder 170 on server 140. In the example method of operation provided in FIG. 9, a call attempt made by the mobile device will result in the outgoing call/message interceptor 107 obtaining the called number contact information by, for example, communicating with dialer 112. Therefore in block 905, the contact finder 170 obtains the called number contact information from the mobile device by communicating with contact tracker 100. The server 140 may then monitor whether the call is successful as shown in decision block 907. If the call is successful in decision block 907, such as what when the called party answers the call, then the method of operation ends in block 931 as shown. However, when a ring back signal persists at the mobile device or when the call is routed to a voicemail server, the contact finder 170 receives information from the corresponding mobile device to that effect and deems the call to be not successful in decision block 907.

In some embodiments, the contact finder 170 may communicate with the contact tracker 100 of the mobile device to notify the user and to request permission to proceed with the search as shown in block 909. An example of such notification message was illustrated in FIG. 4B as notification message 427 which notifies the user of mobile device 110 the call attempt was unanswered or was redirected to voicemail and requests the user's permission to continue to locate the called party. If the user permission is granted in decision block 911, then the searching routine 175 initiates a search of the association map 200 as shown in block 913. In block 915, the searching routine 175 will determine initial search criteria such as, but not limited to, the current date, current time and possibly other information that may be relevant to finding an association map 200 node that may be within proximity of the called party. The searching routine 175 proceeds to search for associated contacts in proximity to the called party in block 917. Further details of block 917 are shown in FIG. 10.

In block 1001 of FIG. 10, the contact finder 170 receives user permission to locate the called party, and in block 1003 proceeds to initiate a search of the association map. The searching routine 175 may initially establish a contact category for the called party as shown in 1005. This categorization procedure was discussed above previously with respect to FIG. 2 where the association map 200 included various categorizations and time associations such as the time association 209 and the family association 207, etc. That is, the searching routine 175 will go through the various decision blocks shown in FIG. 10 to determine whether the called party is a family member as an 1007, the coworker as in 1009, a business contact as in 1011, a social contact is in 1013 or some other generally known contact as in 1015. For a positive result to any of the these decision blocks, the method of operation proceeds to block 1019 and the searching routine 175 identifies and accesses any relevant directories for the specific category. For example if the called party is determined to be a coworker in decision block 1009, the searching routine 175 may look for databases related to the employer that may have information related to that coworker beyond what is already known from contact lists or call logs of the mobile device 110. If none of the decision blocks provide a positive categorization, the method of operation proceeds to decision block 1017 which decides if the called party is contained within the association map 200 at all. If not, then the searching routine 175 will notify the user that data is not available as shown in block 1031 and the method of operation returns to block 919 of FIG. 9. However, if the called party is contained within the association map 200, in other words if a corresponding node exists in the association map 200 in decision block 1017, then the method of operation also proceeds to block 1019. In block 1021, the searching routine 175 searches through the association map 200 and attempts to identify associations between the called party the caller, and other parties based on the date, time of day, and other criteria that may be predefined, etc. and attempts to locate nodes in the association map 200 corresponding to persons who may be within proximity of the called party.

By “proximity” as used herein the present disclosure refers to physical proximity meaning that the candidate person identified by the searching routine 175 has a probability of being physically near the called party and having a mobile device that is operative such that the caller may call the candidates mobile device and attempts to reach the original called party.

Proceeding to decision block 1023, if such other contacts are identified then the searching routine 175 establishes the candidate list in block 1025. In some embodiments, the searching routine 175 may check or verify location information for each of the candidates of the candidate list as shown in block 1027. That is, those candidates who have contact tracker 100 components on their corresponding mobile devices will be able to send location information in some scenarios to the contact finder 170. In such cases, proximity is more readily verified if location available is likewise available for the called party. The contact finder 170 may also check candidate device sensor data, as shown in block 1029, to determine the environment in which the candidate device is situated, and possibly to determine settings of the corresponding mobile device. In other words the searching routine 175 may determine that a certain candidate is within proximity of the called party, but may also determine by obtained sensor data that the candidate's mobile device is set to silent mode. In this case, the searching routine 175 would not consider that candidate to be a viable option for contacting the called party since the candidate's device is likewise unable to inform the candidate that a call attempt is being made. If no other contacts are identified in the decision block 1023, then the method of operation again returns to block 1031 and notifies the user that data is not available.

Returning now to FIG. 9 block 919, the contact finder 170 method of operation enters into a loop operation as shown in block 919 where a number of candidates determined previously in block 917 is designated as index “N.” The looping operation continues provided that the number of candidates, index “N,” and is greater than or equal to one. In block 921, the searching routine 175 may apply the weighting factors that were discussed above to determine the candidate contact with the highest probability of being within proximity to the originally called party. Privacy rules may again be checked for compliance is shown in decision block 923 and if any particular candidate should not be contacted due to privacy rule compliance then the candidate is removed from the contact candidate list as shown in block 925. The index and is then decremented by a factor of one as shown in block 927. Once the index N equals zero as shown in decision block 929, the method of operation ends as shown in block 931. However, as long as N is greater than, or equal to, one the looping operation of block 919 continues. Therefore, at least one candidate contact is selected from the list of candidate contacts and, if privacy rules are complied with in decision block 923, the searching routine 175 will send the contact information for the highest probability as shown block 933, and the method of operation ends in block 931. The user of the corresponding mobile device (that is, the caller) may then attempt to contact the candidate contact in an attempt to reach the original called party.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
detecting that a first call placed by a caller using a first mobile device to a called party using a second mobile device was not answered by the called party using the second mobile device;
determining at least one candidate contact having a third mobile device, an association with the called party, and a probability of being in proximity to the called party at the time of the first call; and
placing a second call using the first mobile device to the third mobile device.

2. The method of claim 1, further comprising:
determining the association of the at least one candidate contact with the called party; and
determining the probability that the at least one candidate is in proximity to the called party at the time of the first call.

3. The method of claim 2, wherein determining the probability that the at least one candidate is in proximity to the called party at the time of the first call, comprises:
generating a list of candidate contacts from an association map, the candidates each having an association with the called party according to the association map; and
determining that the at least one candidate contact has a probability of being in proximity to the called the called party at the time of the first call based on at least one of calendar information, history of communication with the called party, or location information collected from the third mobile device.

4. The method of claim 3, further comprising:
determining the at least one candidate as having a highest probability of being in proximity to the called party from the list of candidate contacts.

5. The method of claim 3, further comprising:
obtaining location information from the third mobile device of the at least one candidate selected from the list of candidates; and
determining that the location information is for a location that is in proximity to the called party at the time of the first call.

6. The method of claim 3, further comprising:
generating the association map by creating a plurality of association map nodes, each node corresponding to a contact in the association map.

7. The method of claim 6, wherein generating the association map comprises:
accessing information on at least one mobile device for each node of the association map, the accessed information comprising call logs, user history, contact lists stored on the mobile device, social networking contact lists, calendar entries, sensor data, or location data.

8. The method of claim 7, wherein generating the association map further comprises:
categorizing a plurality of contacts corresponding to each node of the association map and creating associations for each node based on the categorizations.

9. The method of claim 8, wherein categorizing a plurality of contacts corresponding to each node of the association map comprises:
categorizing a plurality of contacts corresponding to each node as at least one of a family member, coworker, business contact, or social contact.

10. The method of claim 9, further comprising:
creating a time association between the plurality of contacts.

11. A mobile device, comprising:
a dialer, operatively coupled to at least one communication transceiver;
a contact tracker, operatively coupled to the dialer, the contract tracker operative to:
detect that a first call placed by a caller using the mobile device to a called party using a second mobile device was not answered by the called party using the second mobile device;
obtain at least one candidate contact having a third mobile device, an association with the called party, and a probability of being in proximity to the called party at the time of the first call; and
place a second call to the third mobile device.

12. The mobile device of claim 11, wherein the contact tracker is further operative to:
determine the association of the at least one candidate contact with the called party; and
determine the probability that the at least one candidate is in proximity to the called party at the time of the first call.

13. The mobile device of claim 12, wherein the contact tracker is further operative to determine the probability that the at least one candidate is in proximity to the called party at the time of the first call, by:
generating a list of candidate contacts from an association map, the candidates each having an association with the called party according to the association map; and
determining that the at least one candidate contact has a probability of being in proximity to the called the called party at the time of the first call based on at least one of calendar information, history of communication with the called party, or location information collected from the third mobile device.

14. The mobile device of claim 13, wherein the contact tracker is further operative to:
determine the at least one candidate as having a highest probability of being in proximity to the called party from the list of candidate contacts.

15. The mobile device of claim 13, wherein the contact tracker is further operative to:
obtain location information from the third mobile device of the at least one candidate selected from the list of candidates; and
determine that the location information is for a location that is in proximity to the called party at the time of the first call.

16. The mobile device of claim 13, wherein the contact tracker is further operative to:
generate the association map by creating a plurality of association map nodes, each node corresponding to a contact in the association map.

17. The mobile device of claim 16, wherein the contact tracker is further operative to generate the association map by:
accessing information on at least one mobile device for each node of the association map, the accessed information comprising call logs, user history, contact lists stored on the mobile device, social networking contact lists, calendar entries, sensor data, or location data.

18. The mobile device of claim 17, wherein the contact tracker is further operative to generate the association map by:
categorizing a plurality of contacts corresponding to each node of the association map and creating associations for each node based on the categorizations.

19. The mobile device of claim 18, wherein the contact tracker is further operative to categorize a plurality of contacts corresponding to each node of the association map by:
categorizing a plurality of contacts corresponding to each node as at least one of a family member, coworker, business contact, or social contact.

20. The mobile device of claim 19, wherein the contact tracker is further operative to:
create a time association between the plurality of contacts.

21. A system comprising:
a server, operatively coupled to a database, the database containing an association map having a plurality of nodes, each node corresponding to a contact and having at least one association with a different node, each association defining relationship categories comprising at least one of family member, coworker, business contact, or social contact, and location information, time and date for at least one node;
a mobile device, operatively coupled to the server, comprising:
a dialer, operatively coupled to at least one communication transceiver;
a contact tracker, operatively coupled to the dialer, the contract tracker operative to:
detect that a first call placed by a caller using the mobile device to a called party using a second mobile device was not answered by the called party using the second mobile device;
obtain, from the server, at least one candidate contact having a third mobile device, an association with the called party, and a probability of being in proximity to the called party at the time of the first call; and
place a second call to the third mobile device.

22. A method comprising:
determining an intermediary contact for a first contact and a second contact, the intermediary contact selected from groups of contacts where at least a first group of contacts are known to the first contact, at least as second group of contacts are known to the second contact and at least a third group of contacts are known to the first contact and the second contact, the intermediary contact having a probability of being in proximity to the second contact; and
establishing communication between the first contact and the intermediary contact.

23. The method of claim 22, wherein the intermediary contact is selected from groups of contacts where the third group of contacts includes at least a portion of the first group of contacts and at least a portion of the second group of contacts.
